(19) United States
(12) Patent Application Publication
(10) Pub. No.: US 2012/0221411 A1
(43) Pub. Date: Aug. 30, 2012

(54) APPARATUS AND METHODS FOR DETERMINING USER INTENT AND PROVIDING TARGETED CONTENT ACCORDING TO INTENT

(75) Inventor: William W. Graham, JR., Mill Valley, CA (US)

(73) Assignee: CBS INTERACTIVE INC., San Francisco, CA (US)

(21) Appl. No.: 13/034,760

(22) Filed: Feb. 25, 2011

(51) Int. Cl. G06Q 30/00

(52) U.S. Cl. 705/14.52; 705/14.53

(57) ABSTRACT

Various embodiments for providing content targeted from client activity are described. In one or more embodiments, a website may analyze client activity to determine user intent at the website. The website may assign page types to each page at the site, and may map each page type to a section of a sales funnel model. From the analyzed behavior, the website may estimate where the user may be in the sales funnel model and in what subject matter the user is interested. The website may further calculate a confidence in the estimate. The subject matter of interest, the estimated sales funnel section and the confidence measure may be included in an assertion. The content selection service may select content for display to the user based on the assertion. Other embodiments are described and claimed.

### BACKGROUND

Many websites serve advertisements along with the content of the website. Advertisers may pay for ad space based on various contextual criteria, such as page content. However, this context is limited in that it does not take into consideration the behavior of the particular user viewing the page. Different users may arrive at the same web page for different reasons and may navigate the website differently according to their reasons. A user may, for example, be trying to decide which among several competing items to purchase. Another user may be ready to purchase a particular item. Still another may be researching more generally what products and features are available in a particular product category. Accordingly, there may be a need for an improved apparatus and methods for providing targeted advertising from user behavior.

### BRIEF DESCRIPTION OF THE DRAWINGS

FIG. 1 illustrates a first system for targeted advertising in accordance with one or more embodiments.

FIG. 2 illustrates a second system for targeted advertising in accordance with one or more embodiments.

FIG. 3 illustrates an example of a sales funnel and page types that may map to the sales funnel.

FIG. 4 illustrates an embodiment of a sales funnel tracker.

FIG. 5 illustrates an embodiment of a page map.

FIG. 6 illustrates a logic flow in accordance with one or more embodiments.

FIG. 7 illustrates a computing architecture in accordance with one or more embodiments.

### DETAILED DESCRIPTION

Various embodiments are directed to providing content, such as advertising, on a web page where the content is targeted according to the user's behavior within a website. Embodiments may include a mapping between page types within the website to sections of a “sales funnel,” where the sections may represent a user's intent. Embodiments may track a user's interactions with the website and estimate the user's intent from those interactions. The user's estimated intent may be mapped to a section of the sales funnel. The website may provide the estimated section, with a confidence factor and what subject matter the user was interested in, to a content selection service. The content selection service may select content to display to the user based on the section and subject matter.

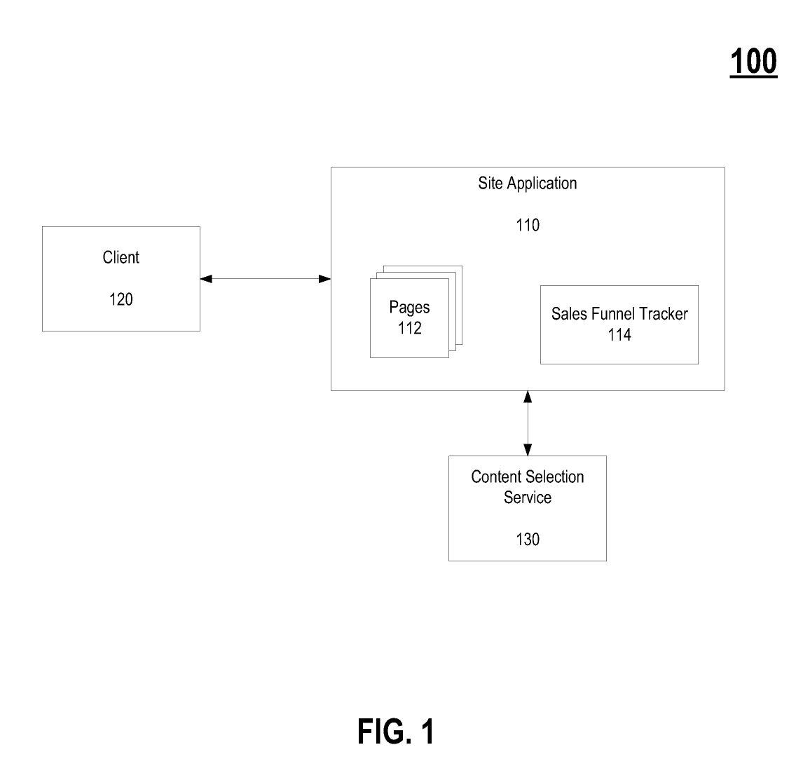

FIG. 1 illustrates a system 100 to provide targeted content based on an estimate of a user's intent from the user's behavior. In one embodiment, for example, the system 100 may comprise a computer-implemented system having multiple components, such as site application 110, client 120, and content selection service 130. As used herein the terms “system” and “component” are intended to refer to a computer-related entity, comprising either hardware, a combination of hardware and software, software, or software in execution. For example, a component can be implemented as a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers as desired for a given implementation. The embodiments are not limited in this context.

In the illustrated embodiment shown in FIG. 1, the system 100 may be implemented by one or more electronic devices. Examples of an electronic device may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. Although the system 100 as shown in FIG. 1 has a limited number of elements in a certain topology, it may be appreciated that the system 100 may include more or less elements in alternate topologies as desired for a given implementation.

The computing entities or devices of system 100 may be communicatively coupled via a network, which may be implemented via various types of communications media, including wired or wireless communications media. The network may implement any well-known communications techniques, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The computing entities or devices of system 100 may include various types of standard communication elements designed to be interoperable with the network, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. One possible communication between computing entities or devices of system 100 can be in the form of a data packet adapted to be transmitted between two or more computer processes. The data packet may include a cookie and/or associated contextual information, for example.

In an embodiment, system 100 may include site application 110. Site application 110 may comprise a network server implementing a website hosting application, a web browser, or other suitable application for serving content to clients, such as client 120. A website may include one or more web pages of text, images, video, audio, hyperlinks, and/or other content types formatted to be viewed in an application such as a web browser, for example, Internet Explorer by Microsoft Corp., Safari by Apple Inc., or Chrome by Google. The pages may include, for example, hypertext markup language (HTML) coded pages, extensible markup language (XML) coded pages, JAVA applets, plain text, and so forth, or a combination thereof.

Site application 110 may serve a number of different web pages containing varied content. The content may include default content that is served to all users, or that is served in the absence of any additional information received or detected about a client's previous on-line activity. The content may also include a section that can be dynamically updated or loaded separately from the rest of the page, where the content for the section may come from content selection service 130 as will be described later. In some cases, the site application 110 may be operated by an entity, such as a corporation, association, or individual, and hosted primarily from one network address.

A site application, such as site application 110, may serve a variety of types of websites, such as, without limitation, a news site, an online storefront, a consumer product information site, a blog, a social networking site, a gaming site, a user forum site, an entertainment site, a sports site, a professional sports site, a college sports site, a high school sports site, a financial services site, a financial products site, and other websites aggregating a certain type or genre of information.

Site application 110 may serve one or more kinds of content. For example, site application 110 may serve consumer information, news, multimedia content, lifestyle content, entertainment content, merchandise, and/or product content. The content may be served as a number of pages 112 from site application 110. Each page 112 of site application 110 may be assigned one or more types. A page type may include, for example: a product page listing a specific product and related information; a category page, e.g. “televisions” or “laptop computers”; a review page where professional and/or user reviews about a specific product are displayed; a search page, where a user may enter a search string or navigate through a series of options to search for information about a product, service, categories of products, etc.; a manufacturer page that displays products offered from one company or manufacturer; or an offers page that displays promotional or sales offers for a product or category of products. Other page types may include, for example, a buying guide page, a product specifications page, a product comparison page, a category home page, or a category listing page. Page types are not limited to these examples. Each page 112 of site application 110 may also be associated with a product, a service, a topic, an organization, or other characteristics that identify aspects of the page that can be used to estimate user intent.

Site application 110 may include a sales funnel tracker 114 to analyze user behavior at site application 110. User behavior may include interactions between client 120 and site application 110, such as, but not limited to, web pages loaded on client 120, search strings entered from client 120, forms filled out, or purchases completed. Sales funnel tracker 114 may examine the data about the pages at site application 110 that a user has viewed. Sales funnel tracker 114 may aggregate and/or analyze, for example, the page types, categories, and/or product types associated with the pages that a user, through client 120, has viewed. Sales funnel tracker 114 may further collect and/or analyze information to determine the subject matter that a user is interested in, for example, a type of product, a service, a news item, a sports team, a hobby, and so forth.

Sales funnel tracker 114 may estimate at which section of a sales funnel the user may be, according to the analyzed behavior and subject matter of interest. A sales funnel may refer to a model of a decision making process, such as the process of deciding to purchase something, where a stage in the process is represented by a section of the funnel. Embodiments may include other “sales funnel” models where a process or an area of interest may be divided into relatively discrete sections. For example, a “sports fan” funnel may have a section for people who like most or all sports generally, another section for people who like a particular sport, and a section for people who like a particular team. For the purpose of the discussion herein, such models will be referred to as a sales funnel, however the term “sales funnel” is not limited to a purchase model.

In order to estimate the sales funnel section that most closely aligns with a user's intent, sales funnel tracker 114 may use a page map that maps a characteristic of a web page to a section of the sales funnel. The page map may, for example, map a page type to a sales funnel section. Other characteristics that may be mapped to a sales funnel section may include a category, a product, a service, a topic, an organization, or other characteristics that identify aspects of the page that can be used to estimate user intent in a sales funnel. Sales funnel tracker 114 may, for example, identify the page type that the client has loaded most, and use the page map to identify the sales funnel section that maps to that page type. Other methods of estimating the sales funnel section that aligns with the user's intent are described further below.

Sales funnel tracker 114 may also apply a confidence measure to the estimate of the sales funnel section. A confidence measure may be useful when the sections of the sales funnel are not completely discrete and/or when the user's behavior appears to indicate more than one possible intent. The confidence measure may be determined, for example, by the relative strength of a page mapping between a page and a sales funnel section, or a weighted average of the different page types visited by the user, as will be discussed in greater detail below.

Sales funnel tracker 114 may provide the estimated sales funnel section, the subject matter of interest to a user and the confidence measure to content selection service 130. Content selection service 130 may use these to select content to provide to site application 110 to display to the user. In an embodiment, sales funnel tracker 114 may use the estimated section, subject matter of interest and the confidence measure to assign the user to a predefined bin, and may provide the bin to content selection service 130 for content selection based on the bin. The bin may be identified by a name or by a unique identifier. When site application 110 is operated by a different entity from content selection service 130, this practice may protect proprietary business information that may be contained in the sales funnel sections and subjects of interest.

Client 120 may be a wired or wireless computing device operating a browser, application viewer or other application program suitable for receiving and displaying content served by site application 110. Client 120 may receive and respond to control directives from a user, for example, input from an input device that causes the browser to connect to a specific website, download a file, fill out a form, follow a hyperlink, and so forth. Client 120 may receive and store information about the user's activity online. For example, client 120 may store a browser history for a browser application operating on client 120. The browser history may maintain a list of all of the website addresses or uniform resource locators (URLs) visited by the user within a certain time period. Client 120 may receive and store cookie files from websites visited, including from site application 110. The cookie files may record actions taken at a particular website, including links followed, search strings entered, a product purchased, and/or metadata associated with the web pages visited at the website. Client 120 may also keep a record of input commands received from a user, output presented on a display for the user, biometric information about the user, sensor information for various sensors implemented by the client 120 (e.g., proximity sensors, motion sensors, environmental sensors, and so forth), applications executing on the client 120, state information for the client 120, and any other information that may assist in predicting or identifying the user's activity online. Additionally or alternatively, another network device may record information about the user's behavior online, such as site application 110, or the content selection service 130, for example. The embodiments are not limited to these examples.

In an embodiment, system 100 may include content selection service 130. Content selection service 130 may be in communication with site application 110. Content selection service 130 may receive information about the estimated sales funnel section, subject matter of interest, and/or the confidence measure from sales funnel tracker 114 via site application 110. The information may be received as one or more separate values, or may be received as a bin identifier where the bin corresponds to the sales funnel section and subject matter of interest. Content selection service 130 may use the received information to select content to be inserted into the content served by site application 110 and displayed to client 120. Content selection service 130 may provide the selected content to site application 110. The selected content may then be inserted into the content served by site application 110 and displayed to client 120, or presented separately from the content served by the site application 110, such as in a separate graphical user interface (GUI) view or web page. The embodiments are not limited in this context.

In an embodiment, content selection service 130 may be a website itself, which selects content to display at site application 110. In another embodiment, content selection service 130 may store and provide content to site application 110 without being accessible independently of site application 110. Content selection service 130 may store and provide content from a plurality of independent sources and select, as a service, which content to provide to site application 110 based on the estimated sales funnel section and area of interest received from site application 110.

Content selection service 130 may be operated by the same entity as for site application 110, or may be independent. In general, the entity or entities that provide content via content selection service 130 desire to display their content to a more specific audience. In an embodiment, content selection service 130 may specify the categories of users or consumers that it can target. The target audiences may be grouped into segments, such as the bins referred to previously. A segment may represent, for example, a demographic, e.g. 30-45 year-old women; an advertising category, e.g. basketball fan; an interest category, e.g. astronomy; a product category, e.g. digital camera; a sales funnel section, e.g. “researching”; and so forth. In another embodiment, site application 110 may specify the targets that content selection service 130 may then select from. The embodiments are not limited in this context.

In general, content selection service 130 may store content to supplement content provided by the site application 110. The content of site application 110 and of content selection service 130 may comprise any multimedia information, including text, audio, video, images, pictures, graphics, icons, and so forth. In an embodiment, content selection service 130 may provide content that is related in some way to content at site application 110. The content provided may also be related to the intent of the user, as estimated from the user's behavior. For example, when a user has viewed a number of pages for different models of a particular product for sale, content selection service 130 may serve content related to independent information, such as reviews or performance metrics, about the product that the user has viewed at site application 110. When a user has purchased a product, content selection service 130 may serve content related to services or products that relate to the purchased product, e.g. a service plan, or peripheral equipment. When a user appears interested in a product, or has purchased a product, content selection service 130 may provide content on social networking opportunities, such as user forums, fan groups, community activities, or other events related to the product, service or content of interest to the user on site application 110. The embodiments are not limited to these examples.

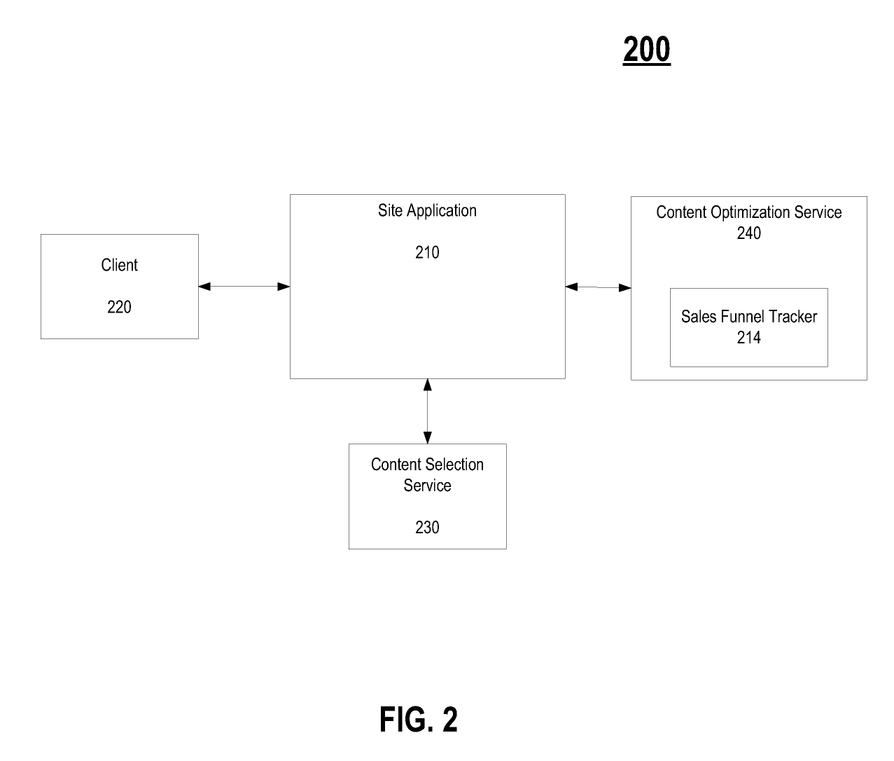

FIG. 2 illustrates a block diagram of a second system 200 to provide targeted content based on an estimate of a user's intent from the user's behavior. System 200 may be analogous to system 100 with the following differences. System 200 may, in addition to site application 210, client 220 and content selection service 230, have content optimization service 240.

Content optimization service 240 may collect information about user intent online. User intent may refer to an area of interest, and activities that indicate a section of a sales funnel model. Information about user intent may include, for example, data about the pages involved in client activity. Client activity may refer to control directives received at client 220 from a user that cause client 220 to request and receive content from site application 210. The control directives may include, for example, selecting a hyperlink with an input device, typing a search string into a search interface, typing a URL into a browser. The data about the pages may include page types, categories, topics, companies, and so forth.

In an embodiment, sales funnel tracker 214 may be a component of content optimization service 240. Sales funnel tracker 214 may receive information, for example, about the pages and/or page types visited by the user, products associated with the visited pages, search strings entered, and other information, from site application 210. Sales funnel tracker 214 may use the information from site application 210 to estimate the sales funnel section, determine the product of interest and calculate the confidence measure. Sales funnel tracker 214 may provide these values to content optimization service 240, which may compare the values against a set of rules or steps to arrive at a segment when a rule is matched or a series of steps is complete in order to classify the user into one or more segments, including bins representing sections of a sales funnel and areas of interest. Content selection service 230 may receive the segment information from content optimization service 240 via site application 210, and may use the segment to select content to insert into the content served by site application 210 and displayed to client 220, or to present separately from the content served by the site application 210, such as in a separate graphical user interface (GUI) view or web page.

In an embodiment, content optimization service 240 may be invoked when a client, such as client 220, initiates a connection to site application 210, for example, by requesting and loading a web page from site application 210. In an embodiment, content optimization service 240 may be invoked from client 220 when the client begins loading the web page from site application 210. The web page may contain a script, such as a Javascript, that runs when the client loads the web page. The script may invoke content optimization service 240. In an embodiment, content optimization service 240 may be invoked by the requested web page from site application 210.

When content optimization service 240 is invoked, the content optimization service 240 may access information about the client activity online. The information may be accessed by content optimization service 240 directly from cookie files placed on client 220 by websites in the same domain as content optimization service 240. The information may be received from site application 210 from, for example, a cookie file placed on client 220 by site application 210, cookie files placed on client 220 by other websites in the same domain as site application 210, a browser history, and/or older activity data stored about that user at site application 210 or content optimization service 240.

In an embodiment, the information from sales funnel tracker 214, e.g. the sales funnel section, product of interest, and/or confidence measure, may be matched against a rule in content optimization service 240 to determine a segment to target. A rule may contain one or more conditions that must be met, whereupon the user will be assigned a segment specified by the rule. For example, a rule may specify that if a user is at least 60% likely to be in a “research” section and is interested in cellular telephones may be placed in a specified segment. When the specified segment is provided to content selection service 230, content selection service 230 may, for example, select an ad for a vendor that carries several brands of cell phones.

In one embodiment (not shown), sales funnel tracker 214 may be a component of site application 210, instead of content optimization service 240. In such an embodiment, sales funnel tracker 214 may provide the collected information about user intent, without analysis, to ad optimization service 240, or may provide the estimated sales funnel section, area of interest and confidence measure to ad optimization service 240.

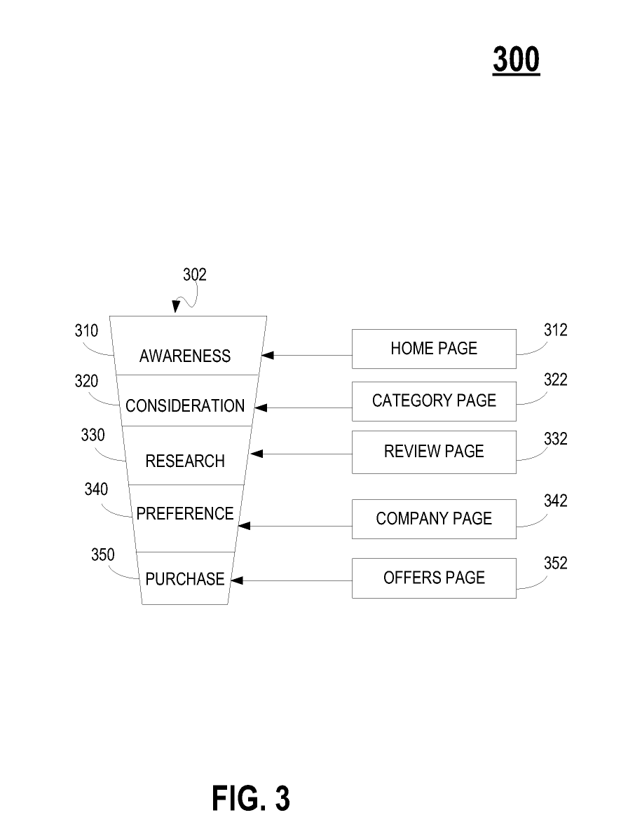

FIG. 3 illustrates an example 300 of a sales funnel 302 and page types that may map to the sales funnel. Sales funnel 302 may have five sections, for example: awareness 310, consideration 320, research 330, preference 340 and purchase 350. A sales funnel may have more or fewer section, and may have different sections than the example illustrated.

Awareness 310 may indicate that a user is aware of the existence of a product or service. Awareness 310 may also be a default section for user behavior that does not meet other sections. User behaviors at site application 110 or 210 that may meet the awareness 310 section may include, for example, viewing the home page of the site, and/or following different links on the site that do not follow a particular product or category, e.g. looking at pages for cameras, washing machines, and reviews for antivirus software.

Consideration 320 may indicate that a user is thinking of purchasing a particular type of product, such as a digital camera or MP3 player, but has not yet reached a decision about desired features, brand or model. User behaviors at site application 110 or 210 that may meet the consideration 320 section may include, for example, following links for a specific product category, and/or entering a search string on a search page for a product category.

Research 330 may indicate that a user is more committed to purchasing a product but needs more information to narrow the selection. User behaviors at site application 110 or 210 that may meet the research 330 section may include, for example, using a compare feature for several product models, viewing product reviews, and/or viewing pages for specific models all related to the same product category.

Preference 340 may indicate that the user has selected a specific product to purchase, or narrowed the selection to a small number of choices, e.g. two or three. The user may, for example, have narrowed the selection to a specific brand or feature set. User behaviors at site application 110 or 210 that may meet the preference 340 section may include, for example, selecting narrowing options on a product display page that allows the user to filter the products displayed by various features such as brand, price, or features. Other behaviors may include viewing pages only from a specific manufacturer and/or product category, or entering a specific item or model number into a search function.

Purchase 350 may indicate that the user has selected a product and is ready to buy it. User behaviors at site application 110 or 210 that may meet the purchase 350 section may include placing a product in a “shopping cart,” and/or viewing a special offers page for a product.

FIG. 3 also illustrates examples of page types that may map to the sections of sales funnel 302. More than one page type may be mapped to a section, and a section may have more than one page type mapped to it. For example, home page 312 may be mapped to awareness 310. Category page 322 may also be mapped to awareness 310. Home page 312 may be more strongly mapped to awareness 310, for example, with a map value of 0.9 (on a scale of 0 to 1), than category page 322, which may have a map value of 0.7.

Category page 322 may also be mapped to consideration 320. Category page 322 may have a map value, for example, of 0.9 for consideration 320. Other page types that may be mapped to consideration 320 may include, for example, a search page, and a review page.

Review page 332 may be mapped to research 330. Other page types that may be mapped to research 330 may include, for example, a company page, a compare page, and a search page.

Company page 342 may be mapped to preference 340. Other page types that may be mapped to preference 340 may include, for example, a category page or a search page.

Offers page 352 may be mapped to purchase 350. Other page types that may be mapped to purchase 350 may include, for example, a shopping cart page. The embodiments are not limited to these examples.

A sales funnel model need not be restricted to stages in a purchasing decision. Other funnel models may be used according to the embodiments. For example, a “level of interest” funnel model that reflects how interested a user is an activity such as a sport or hobby may include sections for observer, supporter, and participant. For example, for a sport, an observer may perform activities such as viewing a television schedule page, or a game schedule on a team page. A supporter may perform activities such as viewing a team schedule page, following a ticket-purchasing link, purchasing a ticket to a game, purchasing team-branded merchandise, or participating in a fan forum page by reading or posting. A participant may perform activities such as purchasing equipment for the sport, or blogging about game highlights.

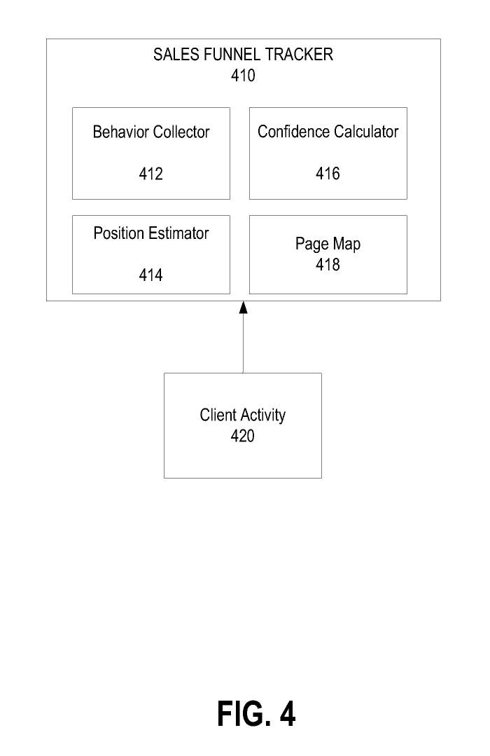

FIG. 4 illustrates an embodiment of a sales funnel tracker 410. Sales funnel tracker may be an embodiment, for example, of sales funnel tracker 114 or 214. Sales funnel tracker 410 may include one or more components to implement its functionality. For example, sales funnel tracker 410 may comprise a behavior collector 412, a position estimator 414, and a confidence calculator 416. Sales funnel tracker 410 may also comprise a page map 418.

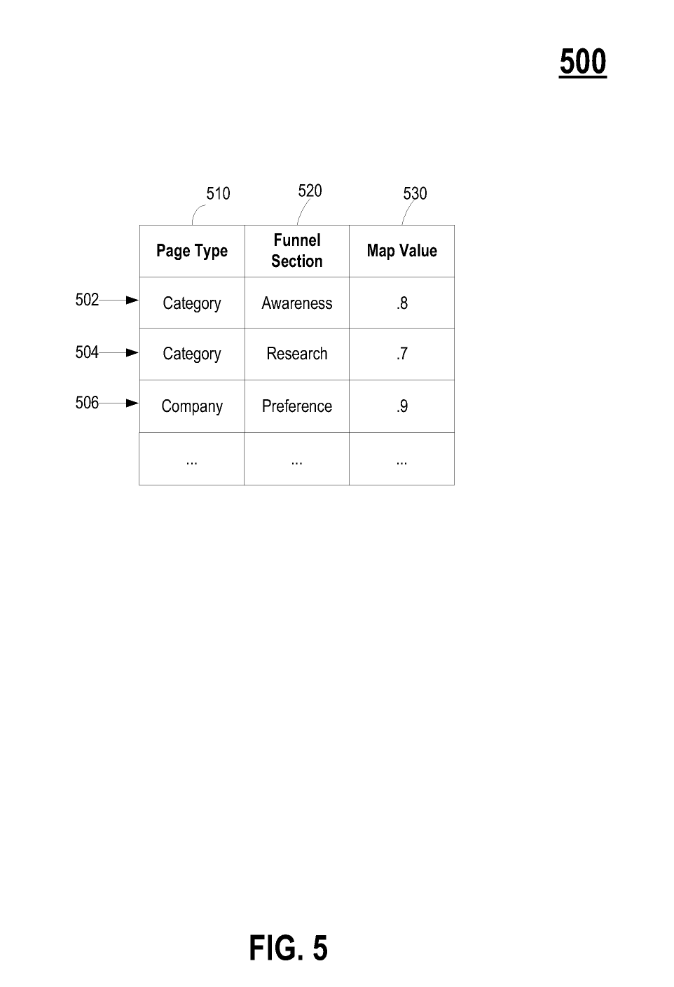

Page map 418 may store the mapping of a page type with a sales funnel section, along with a map value for each pair. The map value may reflect a relative degree to which a page type is associated with a sales funnel section. An example of a page map is illustrated and discussed in FIG. 5 below.

Behavior collector 412 may monitor a user's browsing pattern at site application 110. Behavior collector may monitor incoming client activity 420. Client activity 420 may include, for example, selecting a hyperlink with an input device, typing a search string into a search interface, typing a URL into a browser, loading a page in a browser, and so forth. Behavior collector 412 may also collect data about the pages involved in the activities in client activity 420. The data about the pages may include page types, categories, topics, companies, an absolute or relative time of occurrence for the activity, the page type of a page viewed, a product associated with a page viewed, and so forth. In an embodiment, behavior collector 412 may also read user activities and associated data from a data store, or a cookie, that includes past activities of a user at site application 110. Behavior collector 412 may obtain information about client activity 420 from a URL, for example, when a URL contains a product ID, a category ID, or search terms.

Behavior collector 412 may compile information about client activity 420. For example, for a given user, behavior collector 412 may count the number of times that a page type, a category, or a product is viewed. Behavior collector 412 may, for example, construct a histogram that stores a count for each type of activity and/or each category of data collected from the activity. Behavior collector 412 may perform additional analysis or aggregation on the data collected. For example, behavior collector 412 may compute an average or a weighted average of the number of times that various page types were viewed on a client in a time window. In a weighted average, more recently viewed page types may have more weight as being more indicative of the current intent of the user.

Position estimator 414 may use the data and/or analysis from behavior collector 412 to estimate the user's position in the sales funnel. For example, position estimator 414 may examine the counts of a page characteristic, such as page type, and select, in page map 418, the sales funnel section having the highest map value for the page type having the most views. In an embodiment, position estimator 414 may select the page type having the highest weighted average of views and select, in page map 418, the sales funnel section having the highest map value for the page type selected.

In another embodiment, position estimator 414 may calculate a score for each sales funnel section and select the sales funnel section with the highest score as the estimated section. For example, the score may be a sum of all of the page type views for all of the page types mapped to a sales funnel section, weighted by the map value. For example, suppose page type A and page type B are both mapped to a section C. Page type A is mapped to C with a map value of 0.7 and has 10 views. Page type B is mapped to C with a map value of 0.9 and has 11 views. The score for section C may be (0.7×10)+(0.9×11), or 16.9.

In an embodiment, position estimator 414 may use previously estimated sales function sections as factors in determining what the user's current intent is. For example, if the user has already been estimated to be in the consideration and research sections, it may be more likely that the user is now in the preference section rather than back in the consideration section. Therefore, if two or more sections have relatively similar likelihood of mapping to a user's intent, position estimator 414 may weight a “narrower” sales funnel section more heavily.

In an embodiment, if the user has a score S₁ for being in consideration mode and has viewed the pages mapped to consideration mode during time period A, and has another score S₂ for research mode during time period B, then S₁ or S₂ may be weighted more heavily based on which of A or B is more recent, and the time between A and B. For example, if time B (T_{b}), is greater than time A (Tₐ), then B may be weighted more heavily according to 1+(T_{b}−Tₐ)/(T_{now}−T_{b}). More generally, the weight for any event occurring at time i relative to time j may be calculated by 1+min(N, (Tᵢ−Tⱼ)/(T_{now}−max(Tᵢ, Tⱼ))), where N is a fixed upper bound to keep the weight from approaching infinity and T_{now} is the current time. This equation increases the weight as the time between events increases, and as the recentness of the events decreases. The result is that two events that occurred either long ago or very close to one another may receive only a small up/down weighting. The embodiments are not limited to this example.

In an embodiment, sales funnel tracker 410 may analyze client activity across more than one website. For example, site application 110 may be served in the same domain as several other related or unrelated websites. If site application 110 has access to data about the client activity at those other websites, for example, by reading their cookie files, sales funnel tracker 410 may include the client activity from those other websites in the estimate of sales funnel section. In such a case, page data, such as type and category, may not be consistent between the sites, and may be less relevant to the estimate than subject matter. For example, if a user through a client visits a general news website and views a sports section at the news site, a fantasy league website for a sport, then navigates to an online storefront, the intent of the user to purchase team branded merchandise may be estimated from the sports content and the subsequent visit to the storefront.

Confidence calculator 416 may then calculate a confidence measure for the estimate of the sales funnel section. The confidence measure may indicate the relative strength of the estimate of the user's position in the sales funnel. In an embodiment, the confidence measure may be converted to an adverb describing the strength of the estimate. For example, a user may be described as “might (be)”, “probably”, “most likely”, or “definitely” in a sales funnel section. In an embodiment, the confidence measure may be provided to content selection service 130 as an adverb rather than as a numeric score.

In an embodiment, confidence calculator 416 may calculate a confidence measure from a frequency of page views mapped to the estimated sales funnel section. For example, confidence calculator 416 may calculate the percentage of page views that the estimated section had in a time frame, and compare that percentage to the percentage for the other page types. If, for example, the sales funnel section's page types received more than 50% of all of the page views in the time period, then that may translate to a high confidence measure, such as “most likely”. Similarly, if the section's page types received the most percentage points of all of the page types, e.g. 40% of all page views, where the next highest percentage may be 30%, that may translate to a somewhat high confidence measure, such as “probably.”

In an embodiment, confidence calculator 416 may calculate a weighted count or weighted average of the page type views over a time period for the selected section. More recent page views may be weighted more heavily than less recent page views. Confidence calculator 416 may further weight a count or average with the map value for the selected sales funnel section and the viewed page types for that section. In an embodiment, confidence calculator 416 may compute a relative measure of confidence based on the scores calculated thus far for the estimated purchase funnel section. For example, if scores for three different sections are 40, 37 and 42, then, because the scores are all relatively close to each other, the confidence in each may be low. Further, scores of 10, 12 and 42 might be computed as low, low and high confidence, respectively. Confidence calculator 416 may assign a confidence score based on the previously calculated score. For example, scores in the range of 0-10, 10-30 and >30, may be assigned to low, medium and high confidence, respectively. The embodiments are not limited to these examples.

In an embodiment, confidence calculator 416 may be combined with position estimator 414. As a combined functional unit, they may estimate the sales funnel section and a confidence in that estimate as one functional step. For example, they may estimate the sales funnel section from a sum of page views over a time interval, and calculate a the confidence as a weighted score for the page type with the highest frequency based on the map value of the page type-funnel section pair.

The components of sales funnel tracker 410 may be communicatively coupled via various types of communications media. The components may coordinate operations between each other. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Examples of connections may include parallel interfaces, serial interfaces, and bus interfaces.

FIG. 5 illustrates an embodiment of a page map 500. Page map 500 may be an embodiment, for example, of page map 418. Page map 500 may be in the form of a table, as illustrated. However, page map 500 may be implemented in other forms, such as a database, a relational database, a formatted text file, etc.

In an embodiment, page map 500 may include at least three types of data fields, for example, a page type field 510, a funnel section field 520 and a map value field 530. Page map 500 may have multiple entries, such as entries 502, 504 and 506. Page map 500 may include one entry for each page-type, funnel section pair. In an embodiment, page map 500 may only include entries for page-type, funnel section pairs having a map value 530 above a threshold value, for example, above 0.4.

In an embodiment, sales funnel tracker 410 may store multiple page maps, one for each page type, or one for each sales funnel section. In such an embodiment, a given page map may have two data fields. For example, a page-type page map may have a funnel section data field and a map value data field. The embodiments are not limited to these examples. In an embodiment, a page map may be generated empirically. For example, a large set of previous user sessions that ultimately led to a purchase may be analyzed to determine the aggregate average distribution of page types visited over time to get to that purchase. Similar analysis may be performed for other purchase funnel sections to determine the patterns of occurrence of the various page types.

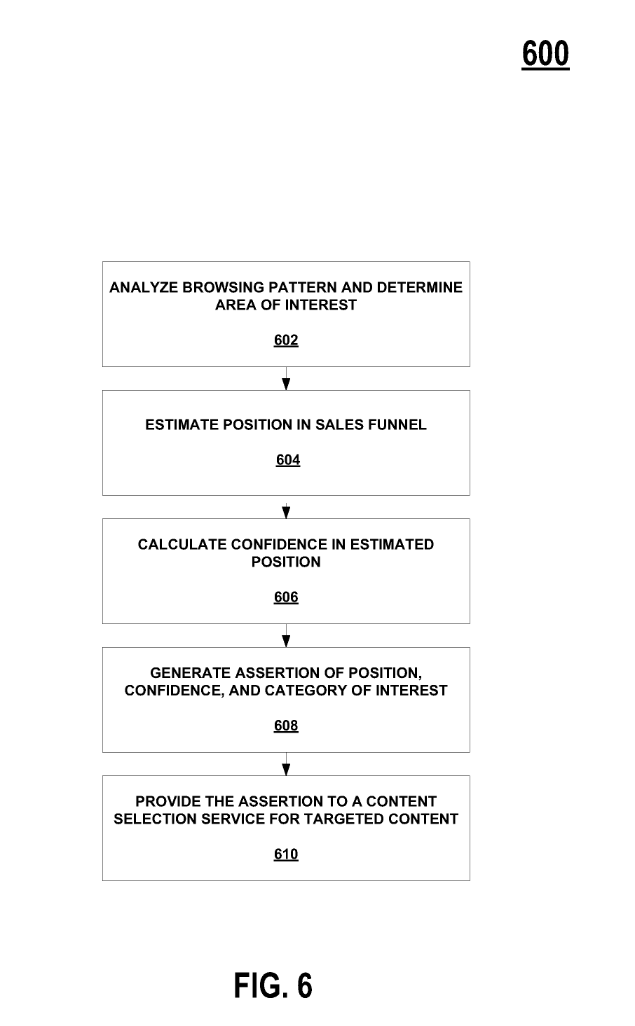

FIG. 6 illustrates a logic flow 600 in accordance with one or more embodiments. The logic flow 600 may be performed by various systems and/or devices and may be implemented as hardware, software, and/or any combination thereof, as desired for a given set of design parameters or performance constraints. For example, the logic flow 600 may be implemented by a logic device (e.g., processor) and/or logic (e.g., threading logic) comprising instructions, data, and/or code to be executed by a logic device. For purposes of illustration, and not limitation, the logic flow 600 is described with reference to FIG. 1. The embodiments are not limited in this context.

In various embodiments, the logic flow 600 may analyze user browsing patterns and determine an area of interest in block 602. For example, sales funnel tracker 114 or 214 may examine client activity, such as client activity 420, to determine what page types the user is viewing, categories of products, page content, or what products are being viewed. Sales funnel tracker 410 may use behavior collector 412 to count the number of times that a page type or a product is viewed. Analyzing user browsing patterns may include computing a weighted average of the number of times a page type was viewed in a time window, for example, with more recently viewed page types having more weight.

Sales funnel tracker 114 or 214 may count the number of views for products, categories, or content associated with pages viewed to determine the area of interest. The product or category having the largest count may be the area of interest, or the most recent products or categories viewed may be the area of interest. In an embodiment, the counts of the page views for each product or category may be weighted by how recently the page was viewed, with more recent views having a larger weight.

In various embodiments, the logic flow 600 may estimate a user position in the sales funnel in block 604. For example, sales funnel tracker 114 or 214 may use the analysis of the user browsing patterns and page map 418 to estimate the user's intent as a position in a sales funnel. As described above, position estimator 414 may examine the counts of page type views, select the page types having the highest number of views, then look up, in page map 418, the sales funnel section having the highest map value for the selected page type. Position estimator 414 may weight the counts of the page type views, for example, with the map value for each potential funnel section, and/or with how recently a page type was viewed. The estimated user position in the sales funnel may then be the section having a highest relative score. Estimating the user position in the sales funnel may include previous estimates for that user. For example, if the user has previously been estimated to be in consideration and research sections, then it is more likely that the present section is preference than awareness.

In various embodiments, the logic flow 600 may calculate a confidence in the estimate of the sales funnel section in block 606. For example, sales funnel tracker 112 or 214 may, from a page type view count, calculate a weighted count or weighted average of the page type views over a time period for the selected sales funnel section. Confidence calculator 416 may weight more recent page views more heavily than less recent page views. Confidence calculator 416 may further, or in the alternative, weight a count or average with the map value for the selected sales funnel section and the viewed page types for that section. The calculated confidence may be in numeric form or may be mapped to a word representing the confidence.

In various embodiments, the logic flow 600 may generate an assertion of user position, confidence and category of interest in block 608. For example, sales funnel tracker 114 or 214 may combine the estimated sales funnel section, confidence measure and the product or category of interest into an assertion statement. The assertion statement may be a natural language construction, such as “The user is probably researching laptop computers,” where “probably” is the confidence, “researching” refers to the research sales funnel section, and “laptop computers” is the product or category of interest. The assertion statement may be a data structure with fields for the confidence, sales funnel section and product/category of interest. The assertion statement may be in a format that content selection service 130 can read and interpret.

In various embodiments, the logic flow 600 may provide the assertion to a content selection service for targeted content placement in block 610. For example, sales funnel tracker 114 or 214 may transmit the assertion statement to content selection service 130, or to content selection service 130 via content optimization service 240. Content selection service 130 may use the assertion to select content for display at site application 110 that is targeted to the user's intent.

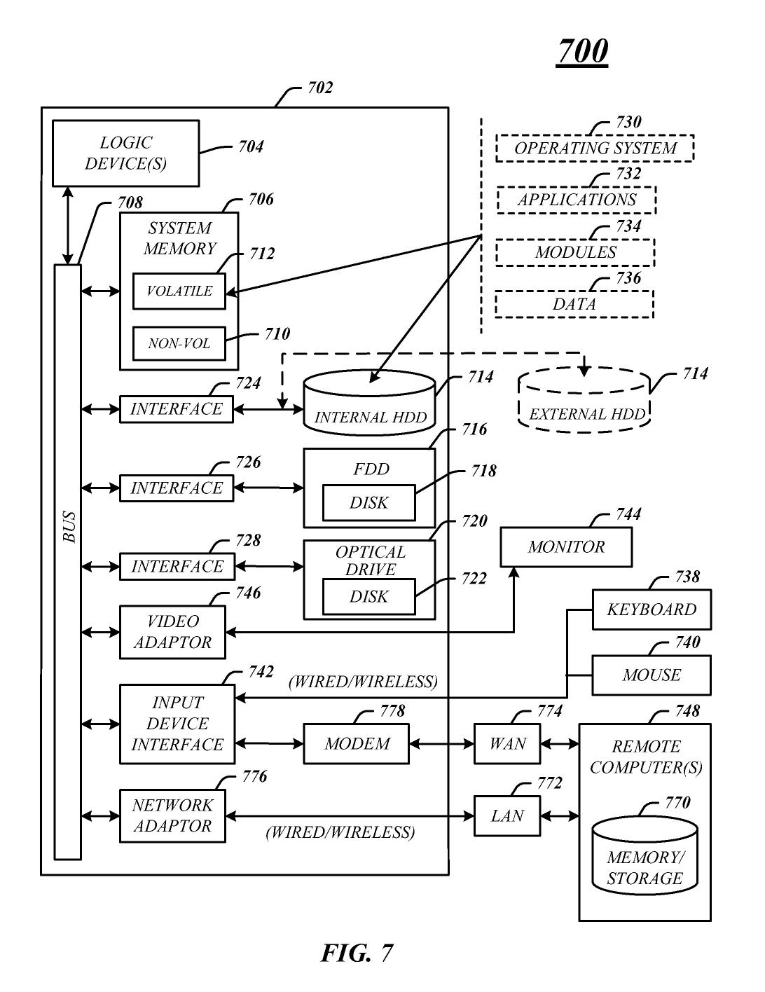

FIG. 7 illustrates a computer architecture in accordance with one or more embodiments, suitable for implementing various embodiments as previously described. The computing architecture 700 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 700.

As shown in FIG. 7, the computing architecture 700 comprises logic device(s) 704, a system memory 706 and a system bus 708. Examples of a logic device may include, without limitation, a central processing unit (CPU), microcontroller, microprocessor, general purpose processor, dedicated processor, chip multiprocessor (CMP), media processor, digital signal processor (DSP), network processor, co-processor, input/output processor, application specific integrated circuit (ASIC), field programmable gate array (FPGA), programmable logic device (PLD), and so forth. Dual microprocessors and other multi-processor architectures may also be employed as the logic device(s) 704. The system bus 708 provides an interface for system components including, but not limited to, the system memory 706 to the logic device(s) 704. The system bus 708 can be any of several types of bus structure that may further interconnect to a memory bus (with or without a memory controller), a peripheral bus, and a local bus using any of a variety of commercially available bus architectures.

The system memory 706 may include various types of memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 7, the system memory 706 can include non-volatile memory 710 and/or volatile memory 712. A basic input/output system (BIOS) can be stored in the non-volatile memory 710.

The computer 702 may include various types of computer-readable storage media, including an internal hard disk drive (HDD) 714, a magnetic floppy disk drive (FDD) 716 to read from or write to a removable magnetic disk 718, and an optical disk drive 720 to read from or write to a removable optical disk 722 (e.g., a CD-ROM or DVD). The HDD 714, FDD 716 and optical disk drive 720 can be connected to the system bus 708 by a HDD interface 724, an FDD interface 726 and an optical drive interface 728, respectively. The HDD interface 724 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 710, 712, including an operating system 730, one or more application programs 732, other program modules 734, and program data 736. The one or more application programs 732, other program modules 734, and program data 736 can include, for example, behavior collector 412, position estimator 414, confidence calculator 416 and page map 418.

A user can enter commands and information into the computer 702 through one or more wire/wireless input devices, for example, a keyboard 738 and a pointing device, such as a mouse 740. Other input devices may include a microphone, an infra-red (IR) remote control, a joystick, a game pad, a stylus pen, touch screen, or the like. These and other input devices are often connected to the logic device(s) 704 through an input device interface 742 that is coupled to the system bus 708, but can be connected by other interfaces such as a parallel port, IEEE 1394 serial port, a game port, a USB port, an IR interface, and so forth.

A monitor 744 or other type of display device is also connected to the system bus 708 via an interface, such as a video adaptor 746. In addition to the monitor 744, a computer typically includes other peripheral output devices, such as speakers, printers, and so forth.

The computer 702 may operate in a networked environment using logical connections via wire and/or wireless communications to one or more remote computers, such as a remote computer 748. The remote computer 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wire/wireless connectivity to a local area network (LAN) 752 and/or larger networks, for example, a wide area network (WAN) 754. Such LAN and WAN networking environments are commonplace in offices and companies, and facilitate enterprise-wide computer networks, such as intranets, all of which may connect to a global communications network, for example, the Internet.

When used in a LAN networking environment, the computer 702 is connected to the LAN 752 through a wire and/or wireless communication network interface or adaptor 756. The adaptor 756 can facilitate wire and/or wireless communications to the LAN 752, which may also include a wireless access point disposed thereon for communicating with the wireless functionality of the adaptor 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wire and/or wireless device, connects to the system bus 708 via the input device interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with wire and wireless devices or entities using the IEEE 802 family of standards, such as wireless devices operatively disposed in wireless communication (e.g., IEEE 802.7 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.7x (a, b, g, etc.) to provide secure, reliable, fast wireless connectivity. A Wi-Fi network can be used to connect computers to each other, to the Internet, and to wire networks (which use IEEE 802.3-related media and functions).

Numerous specific details have been set forth to provide a thorough understanding of the embodiments. It will be understood, however, that the embodiments may be practiced without these specific details. In other instances, well-known operations, components and circuits have not been described in detail so as not to obscure the embodiments. It can be appreciated that the specific structural and functional details are representative and do not necessarily limit the scope of the embodiments.

Various embodiments may comprise one or more elements. An element may comprise any structure arranged to perform certain operations. Each element may be implemented as hardware, software, or any combination thereof, as desired for a given set of design and/or performance constraints. Although an embodiment may be described with a limited number of elements in a certain topology by way of example, the embodiment may include more or less elements in alternate topologies as desired for a given implementation.

References to “one embodiment” or “an embodiment” mean that a particular feature, structure, or characteristic described in connection with the embodiment is included in at least one embodiment. The appearances of the phrase “in one embodiment” in the specification are not necessarily all referring to the same embodiment.

Although some embodiments may be illustrated and described as comprising exemplary functional components or modules performing various operations, it can be appreciated that such components or modules may be implemented by one or more hardware components, software components, and/or combination thereof. The functional components and/or modules may be implemented, for example, by logic (e.g., instructions, data, and/or code) to be executed by a logic device (e.g., processor). Such logic may be stored internally or externally to a logic device on one or more types of computer-readable storage media.

It also is to be appreciated that the described embodiments illustrate exemplary implementations, and that the functional components and/or modules may be implemented in various other ways which are consistent with the described embodiments. Furthermore, the operations performed by such components or modules may be combined and/or separated for a given implementation and may be performed by a greater number or fewer number of components or modules.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within registers and/or memories into other data similarly represented as physical quantities within the memories, registers or other such information storage, transmission or display devices.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other. With respect to software elements, for example, the term “coupled” may refer to interfaces, message interfaces, API, exchanging messages, and so forth.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. In addition, the logic flow may be implemented by a hardware element, a software element executed by a processor, or any combination thereof.

While certain features of the embodiments have been illustrated as described above, many modifications, substitutions, changes and equivalents will now occur to those skilled in the art. It is therefore to be understood that the appended claims are intended to cover all such modifications and changes as fall within the true spirit of the embodiments.

1. A computer-implemented method comprising:
analyzing a browsing pattern of a client at a website;
determining an area of interest using the analysis;
estimating a position in a sales funnel using the analysis, the sales funnel comprising at least two sections; and
providing the estimated position and the area of interest to a content selection service for targeted advertising to the user.

2. The method of claim 1, wherein the website comprises a plurality of pages;
wherein each page on the website is assigned at least one page type;
wherein a page type is mapped to at least one section of the sales funnel; and
wherein a page may be associated with at least one of: a product, a category, a topic, and a manufacturer.

3. The method of claim 2, wherein a page type comprises: a product page, a product review page, a product offer page, a category page, a search page, a manufacturer page, a buying guide page, a product specifications page, a product comparison page, a category home page, a social networking page, a forum page, or a category listing page.

4. The method of claim 2, wherein determining the area of interest comprises:
counting a first number of views within a time window for at least one of: a product page, a manufacturer page, a topic, or a category page; and
selecting the product, manufacturer, topic, or category having the highest first number of views as the area of interest.

5. The method of claim 2, wherein analyzing the browsing pattern comprises: counting a second number of views for each page type within a time window.

6. The method of claim 5, wherein estimating the position comprises:
selecting the page type having the largest second number of views; and
using the selected page type to select a sales funnel section as the estimated position.

7. The method of claim 6, further comprising:
calculating a confidence in the estimated position based on the second number of views of the selected page type and a weighting factor;
generating an assertion comprising the estimated position, the confidence, and the area of interest; and
providing the assertion to the content selection service.

8. The method of claim 7, the weighting factor comprising at least one of:
a time of the page views for the selected page type; and
a map value that reflects a relative degree to which a page type maps to a sales funnel section.

9. An apparatus comprising:
a logic device;
a sales funnel tracker operative on the logic device to receive client activity at a website, the sales funnel tracker comprising:
a behavior collector to analyze a browsing pattern from the client activity and determine an area of interest using the analysis; and
a position estimator to estimate the position in a sales funnel using the analysis, the sales funnel comprising at least two sections.

10. The apparatus of claim 10, further comprising:
a site application operative on the logic device to operate the website, the website comprising a plurality of pages, wherein each page on the website is assigned at least one page type; a page type is mapped to at least one section of the sales funnel; and a page may be associated with at least one of: a product, a category, a topic, and a manufacturer.

11. The apparatus of claim 10, the behavior collector to:
count a first number of views within a time window for at least one of: a product page, a manufacturer page, a topic, or a category page;
select the product, manufacturer, topic, or category having the highest first number of views as the area of interest; and
count a second number of views for each page type within a time window.

12. The apparatus of claim 11, the position estimator to:
select the page type having the largest second number of views; and
use the selected page type to select a sales funnel section as the estimated position.

13. The apparatus of claim 10, the sales funnel tracker further comprising:
a page map comprising an entry for a unique pair of a page type and a sales funnel section, wherein each entry comprises a map value that reflects a relative degree to which the page type maps to the sales funnel section; and
a confidence calculator to calculate a confidence measure of the estimate.

14. The apparatus of claim 13, the confidence calculator to:
calculate a confidence in the estimated position based on the second number of views of the selected page type and a weighting factor;
generate an assertion comprising the estimated position, the confidence, and the area of interest; and
provide the assertion to one of a content selection service or a content optimization service for targeted content to the client.

15. The apparatus of claim 14, the weighting factor comprising at least one of:
a time of the page views for the selected page type; and
the map value in the page map for the selected page type and estimated sales funnel section.

16. A machine-readable storage medium comprising instructions that when executed cause a computing system to:
analyze a browsing pattern of a client at a website, the website comprising a plurality of pages, each page having a page type, and each page mapped to at least one section of a sales funnel;
determine an area of interest using the analysis;
estimate a position in the sales funnel using the analysis;
calculate a confidence measure for the estimate; and
provide the estimated position, confidence measure, and the area of interest to a content selection service for targeting content to the user.

17. The storage medium of claim 16, further comprising instructions that when executed enable the computing system to:
count a number of views for each page type within a time window;
weight the number of views according to a time when a page was viewed; and
select the page type having the largest weighted count.

18. The storage medium of claim 17, further comprising instructions that when executed enable the computing system to:
estimate the position in the sales funnel as the sales funnel section mapped to the selected page type.

19. The storage medium of claim 18, wherein when a sales funnel section is mapped to more than one page type, the storage medium further comprising instructions that when executed enable the computing system to:
select, in a page map, the sales funnel section having a largest map value to the selected page type;
wherein the page map comprises an entry for a unique pair of a page type and a sales funnel section, wherein each entry comprises the map value that reflects a relative degree to which the page type maps to the sales funnel section.

20. The storage medium of claim 16, further comprising instructions that when executed enable the computing system to:
provide the confidence measure to the content selection service as a natural language word.
